(19) United States
(12) Patent Application Publication
(10) Pub. No.: US 2011/0005995 A1
(43) Pub. Date: Jan. 13, 2011

(54) Fluid filter and method of construction

(75) Inventors: David McMahon Butler, Lenoir City, TN (US); Johnny James Clark, Lenoir City, TN (US)

Correspondence Address: W. ALLEN MARCONTELL, P.O. BOX 800149, HOUSTON, TX, 77280-0149, US

(73) Assignee: Filmax, Inc., Loudon, TN (US)

(21) Appl. No.: 12/459,790

(22) Filed: Jul. 8, 2009

(51) Int. Cl. B01D 29/15; B29D 23/00

(52) U.S. Cl. 210/437; 156/187

(57) ABSTRACT

An axial flow depth filter having a cellulose filter medium of tissue paper spirally wound about a paperboard core is secured to a paperboard inner flow tube for operation by a full surface coating of high performance polyamide hot melt adhesive applied between the I.D. of the paperboard core and the O.D. of the inner flow tube along the entire axial length of the core.

### CROSS-REFERENCE TO RELATED APPLICATION

Not applicable

### BACKGROUND OF THE INVENTION

1. Field of the Invention

This invention relates to axial flow depth filters having particular utility for maintaining fluids such as water and water based fluids, petroleum and synthetic based fluids, glycols and glycerin based fluids. The maintenance and care of lubricants for transmissions, hydraulic systems and electric power transmission insulation are among the many uses and applications for the present invention.

2. Description of Related Art

Filters for removing accumulations of contaminates and undesirable matter from fluids are well known. There are many variations in filter design and application. However, most fluid filters have inflow and outflow conduit ports located on the wall of a closed vessel and one or more filter elements within the vessel. A space is often provided between the filter elements and the vessel wall for containing the unfiltered fluid before it enters the filter elements.

In the case of axial flow depth filters, the filtration medium may comprise a length of tissue paper (cellulose) wound (reeled) over a paperboard core. Fluid flow through the filter is from one axial end of the reel to the other, parallel with the reel axis, between the paper sheet layers. Contamination removal is by the mechanisms of absorption and adsorption. The pressure differential across the filter medium between opposite axial ends (inlet and outlet) of the reel is a function of the fluid characteristics such as viscosity, temperature and flow rate through the medium. Such pressure differential produces substantial hydraulic compression on the filter elements which tends to deform and distort the elements.

Many filter applications include a variable fluid flow rate. Consequently, the pressure differential across the filter medium is proportionally variable. Such pressure fluctuations tend to stress the filter elements with alternating periods of compression. Over time, this compressive stress compromises the structural integrity of the medium assembly. One consequential result of this stress is to permit unfiltered fluid to bypass the filter medium along direct flow channels between the filter inlet and outlet. These direct channels are opened by stress induced structural distortions and failures.

One configuration of an axial flow depth filter includes a pair of cellulose medium (tissue weight paper) reels of that are aligned concentrically over an intermediate flow tube. A core tube about which the cellulose medium is wound may be fabricated of impregnated or unimpregnated paper. If the core composition material is impregnated paper, the densely laid core medium is often (not always) saturated with phenolic resin.

The intermediate flow tube is also fabricated of densely wound cellulose sheet that may or may not be impregnated. The intermediate flow tube may be given a greater or less wall thickness than the core tube.

The length of the intermediate flow tube is usually but not necessarily greater than the sum of the two cooperative core tube lengths to provide a small separation space between the inner ends of the two reels for an exit flow channel. The circular outer periphery of this reel separation space is sealed to prevent the entry of unfiltered fluid into the space. Apertures through the intermediate flow tube wall between adjacent core tube ends provide fluid flow channels for filtered fluid from the separation space into the bore of the intermediate flow tube. Fluid exit flow from the separation space is therefore restricted to the apertures in the intermediate flow tube wall.

Assembly procedures of a preferred embodiment require an axially sliding fit between the inside diameter of a medium core tube and the outside diameter of the intermediate flow tube. A sliding relative fit between the two cylindrical surfaces necessarily requires some annular space or looseness between the two surfaces. This separation space must be sealed by some means to prevent unfiltered fluid from bypassing the medium channels along the separation space into the intermediate flow tube apertures.

Coaxially within the intermediate flow tube is an exit flow tube. The exit flow tube is usually fabricated of a durable material such as metal. However, composites or dense plastics mat adequately serve this purpose as well. An annulus between the intermediate flow tube bore and the exit flow tube outer surface at the opposite distal ends of the intermediate flow tube is sealed by respective end plugs. Fluid flow from the intermediate flow tube annulus is channeled into the inner flow bore of the exit flow tube.

Many axial flow filters of prior art design provide annulus plugs in the intermediate flow tube having radially projecting flanges that compressively overlie the outer distal ends of the respective paperboard medium cores. According to these prior art designs, a cylindrical interface between the paperboard medium core and the paperboard flow tube is intended to be sealed from contaminated fluid entry by the radial flange portion of the respective flow tube end plug. Unfortunately, time and service distortion often compromises this seal thereby allowing unfiltered fluid to bypass the medium along the interface between the inner surface of the reel core and the outer surface of the intermediate flow tube. This bypass flow route allows the unfiltered fluid to enter the filtered flow stream at the reel separation space.

### SUMMARY OF THE INVENTION

The present invention successfully addresses a fluid contamination problem along the assembly interface of an axial flow depth filter between the reel core and the intermediate flow tube by sealing the entire contiguous surface length between the core and the flow tube with a high performance, hot melt adhesive having an approximately 345° to 363° F. softening temperature and an approximately 400° F. application temperature. The approximate viscosity of the preferred adhesive at 375° F. is about 4,175 cP and about 1,800 to 3,800 cP at 400° F.

Upon assembly, sufficient hot adhesive is distributed about the exterior surface of the corresponding end of an intermediate flow tube to substantially fill all space and cover all contiguous surfaces between the core and the intermediate flow tube as the flow tube is inserted into the bore of the reel core. This adhesive penetrates the application surface of the core and flow tube and bridges any annular space between the two surfaces.

### BRIEF DESCRIPTION OF THE DRAWINGS

The advantages and further features of the invention will be readily appreciated by those of ordinary skill in the art as the same becomes better understood by reference to the following detailed description when considered in conjunction with the accompanying drawings in which like reference characters designate like or similar elements throughout.

FIG. 1 is a cross-sectional view of a preferred embodiment of the invention that comprises two filter assemblies, each having a pair of filter medium reels.

FIG. 2 is a cross-sectional detail of a filter assembly.

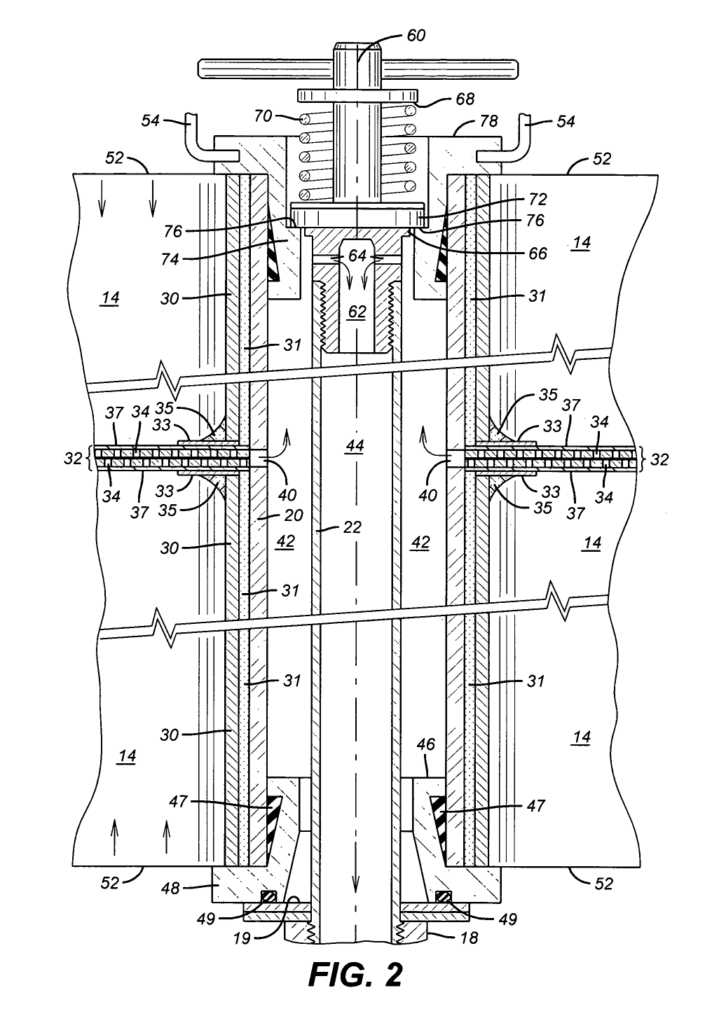

### DESCRIPTION OF THE PREFERRED EMBODIMENTS

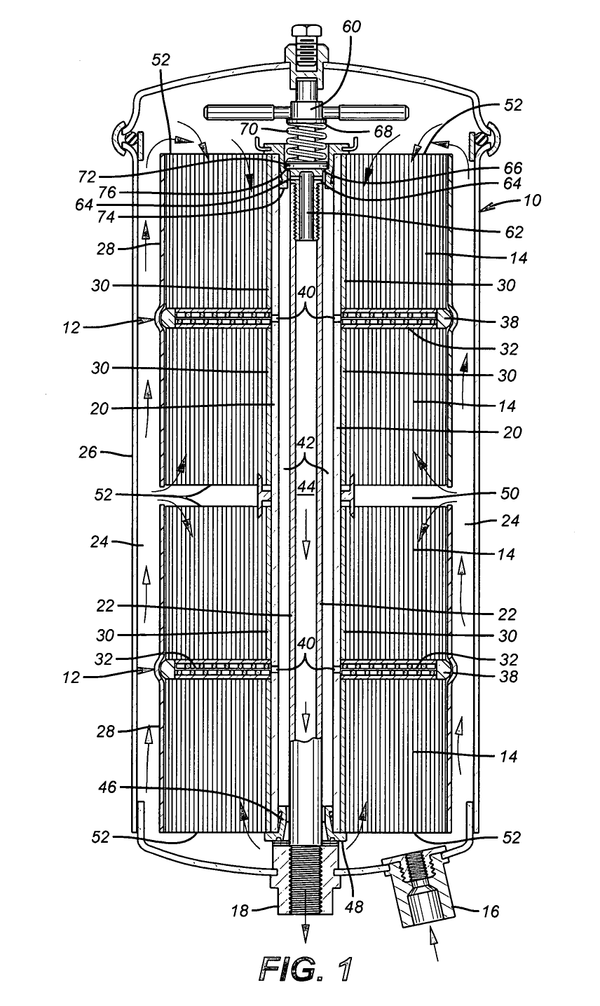

Referring to FIG. 1 of the drawing, an axial flow depth filter apparatus is shown to comprise a closed pressure canister 10 having an inlet fluid flow fixture 16 and an exit flow fixture 18. Within the canister 10 are two filter assemblies 12 in coaxial alignment along an intermediate flow tube 20. Coaxially within the intermediate flow tube 20 is an exit flow tube 22. In operation, the annulus 24 within the canister shell 26 and around the filter assemblies 12 is filled with contaminated fluid.

Each filter assembly 12 of FIG. 1 comprises two reels 14 of filter medium. The construction of each reel 14 includes a sized or unsized paperboard core 30. The active filter medium is an elongated sheet of sized or unsized, tissue weight, cellulose filter medium (paper) wound about each of the cores 30. The inside diameter of each core 30 is dimensioned to a close sliding fit over the outside diameter of the intermediate flow tube 20. The reel 14 position along the intermediate flow tube 20 is secured by a full surface application of hot melt adhesive 31 between the contiguous core 30 and intermediate flow tube 20 surfaces to bridge any space or spaces between the two surfaces. Preferably, the adhesive for this application is a high performance polyamide hot melt adhesive having an application temperature of about 400° F. The H.B. Fuller Co. of St Paul Minn. product number HL-6608 is representative. This H.B. Fuller product is specified as having a softening point at about 345° to 363° F. The 375° F. viscosity is about 4,175 cP whereas the 400° F. viscosity is about 1,800 to about 3,800 cP. By “full surface application”, it is meant that the hot melt adhesive coats substantially the entire inside bore surface of each reel core 30. The term “bridging” may also be used to describe filling of all space between the reel core 30 and the intermediate flow tube 20. Prior art assemblies have attempted to prevent the filter bypass of contaminated fluid along this route between the core 30 and the intermediate flow tube 20 by a line or bead application of adhesive around the annulus between the two surfaces. In certain service circumstances or applications, however, such as a high flow rate of high temperature oil, the beaded seal line of such prior art construction between the core 30 and the intermediate flow tube 20 may be compromised.

The two reels 14 respective to each filter assembly 12 are aligned axially along the intermediate flow tube 20 to a small separation space 32. Preferably, each of the reel 14 annular ends adjacent the space 32 and at the opposite distal end of the core 30 are reinforced with a paperboard collar secured by a bead of adhesive 35. An annular filter sheet 37 overlays the annular exit flow face of each reel 14. Between the adjacent filter sheets 37 are a pair of perforated discs 34. The outer perimeter of the filter sheers 37 and perforated discs 34 is secured to the reel 14 medium by a non-porous perimeter seal 38 such a the H.B. Fuller hot belt adhesive product described above, Sealing the space 32 outer perimeter prevents a communication of contaminated fluid from the canister annulus 24 into the filtered fluid space 32.

FIG. 1 illustrates the supplemental use of an outer perimeter seal of plastic film 28 around each assembly 12. It should be understood that the cellulose filter medium 14 does not readily pass fluid transversely of the cellulose sheet plane. Accordingly, it is not normally necessary to seal the reels of filter medium 14 from radial penetration of contaminated fluid. For such reason, the perimeter seal 28 is not considered to be an essential element of the invention combination. In some installations, the plastic film 28 is applied as a primary or redundant seal for the outer perimeter of filtered fluid flow space 32.

Fluid flow apertures 40 through the intermediate flow tube 20 wall adjacent the reel separation spaces 32 provide fluid flow channels from the separation spaces 32 into the intermediate flow tube annulus 42.

Another separation space 50 is provided between the adjacent assembly 12 ends. This space 50 is open to the canister annulus 24 and provides an entry flow channel for contaminated fluid into the adjacent interior entry faces for the medium reels 14. There is, however, no flow aperture through-the intermediate flow tube 20 wall adjacent the separation space 50.

The exit flow tube 22 is secured at one end by threads into the exit flow fixture 18. An annulus plug 46 seals the intermediate flow tube annulus 42 at the exit flow end. Radial flanges 48 from the plug 46 bear against the lower distal end of intermediate flow tube 20. Seals 47 of H.B. Fuller HL-6608 adhesive bear against the inside bore wall of the intermediate flow tube 20 and an O-ring 49 bears against the seal face 19 of the exit flow fixture 18.

The opposite or upper end of the exit flow tube 22 is threaded or welded to receive an assembly bolt 60. The assembly bolt is bored 62 from the distal end to open into the flow bore 44 of the exit flow tube 22. The wall of the bolt 60 is perforated by apertures 64 into the bore 62 at a position located axially along the bolt from the distal end to place the apertures 64 in fluid communication with the intermediate flow tube annulus 42. Above the apertures 64 is a limit shoulder 66. A compression spring 70 applies a resilient bias against a seating ring 72 from an upper shoulder 68 toward the limit shoulder 66. When the assembly bolt is threaded to full depth into the exit flow tube 22, the seating ring 72 engages an internal shoulder 76 of an upper annulus plug 74. The plug 74 is secured to the internal bore of the intermediate flow tube 20 by a bead of the HL-6608 adhesive that is injected through an aperture (not shown) in the plug 74 for circumferential distribution around a perimeter channel in outside surface of the plug 74 An external flange portion 76 of the annulus plug 74 bears upon the upper distal ends of the intermediate flow tube 20 and the upper end of reel core 30. The spring 70 resilient compression force of closely controlled magnitude is thereby imposed upon the length of the intermediate flow tube 20 between the opposite distal ends. A lifting bail 54 is conveniently secured to the annulus plug 74 flange 76.

Operationally, contaminated fluid enters the canister 10 through the inlet flow fixture 16 and courses around the canister annulus 24. The contaminated fluid enters the filter assemblies 12 at the media open ends 52. Fluid flow within the media is between the tissue sheet layers parallel with the core 30 axis.

The filtered fluid exits the medium traverse into the medium separation space 32 to flow radially through the apertures 40 into the intermediate flow tube annulus 42. Filtered fluid flows within the annulus 42 toward the assembly bolt 60 and through the apertures 64 into the bolt bore 62. From the bolt bore 62, the filtered fluid flows along the flow bore 44 of the exit flow tube 22 and through the exit flow fixture 18.

The foregoing specification has described an axial flow depth filter having two filter assemblies 12 operating in a parallel flow circuit. Obviously, a filter assembly may be constructed using the present invention with only one assembly 12. Similarly, filters may be constructed using the present invention principles as described above having three, four, six, eight or more assemblies 12. A primary criterion for determining the number of assemblies in a specific application is the most desirable flow rate of fluid to be treated through the filter.

Although the invention disclosed herein has been described in terms of specified and presently preferred embodiments which are set forth in detail, it should be understood that this is by illustration only and that the invention is not necessarily limited thereto. Alternative embodiments and operating techniques will become apparent to those of ordinary skill in the art in view of the present disclosure. Accordingly, modifications of the invention are contemplated which may be made without departing from the spirit of the claimed invention.

1. An axial flow filter apparatus for filtering contaminants of a fluid flow stream comprising:
a closed pressure vessel having an inlet and exit fluid flow fixture;
a filter assembly within said closed vessel comprising a pair of filter media reels, each reel having a length of light weight cellulose filter medium wound about a respective paper board core tube, said pair of media reels being axially aligned over a first flow tube with substantially all of internal bore surfaces respective to said core tubes adjacent substantially concentric external surfaces of said first flow tube;
an adhesive coating on said first flow tube external surface and substantially all of said core tube internal surfaces, said coating substantially filling all space between said surfaces;
a filtered fluid flow space between adjacent annular end faces of said media reels; and,
one or more apertures in said first flow tube between said filtered fluid flow space and an internal bore space of said first flow tube; and,
means for channeling filtered fluid flow from said first flow tube bore space into said exit fluid flow fixture.

2. An axial flow filter as described by claim 1 wherein said adhesive coating is a polyamide hot melt adhesive.

3. An axial flow filter as described by claim 2 wherein said adhesive coating has an approximately 400° F. application temperature.

4. An axial flow filter as described by claim 3 wherein said adhesive coating has an application viscosity of about 1800 to 3800 cP.

5. An axial flow filter as described by claim 1 wherein said means to channel filtered fluid flow from said first flow tube into said exit fluid flow fixture comprises a second, exit flow tube concentrically within said first flow tube,

6. An axial flow depth filter assembly comprising:
a paperboard core tube having an axial interior bore surface;
a length of cellulose filter medium reeled about said core tube to provide an inlet fluid flow annulus at one axial end of said core tube and an exit fluid flow annulus at the opposite axial end of said core tube;
an exit flow tube having and internal flow bore and a substantially cylindrical external surface positioned concentrically within said core tube bore surface;
a hot melt adhesive substantially filling any space between said core tube bore surface and said flow tube external surface, said adhesive filling being substantially continuous between said inlet flow end said core tube and the exit flow end of said core tube; and,
means for channeling fluid flow into said inlet flow annulus and from said exit flow annulus into said flow bore of said exit flow tube.

7. An axial flow filter as described by claim 6 wherein said adhesive is a polyamide hot melt adhesive.

8. An axial flow filter as described by claim 7 wherein said adhesive has an approximately 400° F. application temperature.

9. An axial flow filter as described by claim 8 wherein said adhesive has an application viscosity of about 1800 to 3800 cP.

10. A method of fabricating an axial flow depth filter assembly comprising the steps of:
winding a sheet of cellulose filter medium about a paperboard core having a substantially cylindrical inside diameter bore surface;
providing a substantially cylindrical paperboard flow tube having an outside diameter substantially corresponding to the inside diameter of said core bore to accommodate a close sliding fit between contiguous surfaces of said core over said flow tube;
coaxially inserting said flow tube along the full length of said core bore; and,
providing a continuous hot melt adhesive coating of contiguous core and flow tube surfaces to substantially fill all space therebetween.

11. A method of fabricating an axial flow depth filter assembly as described by claim 10 wherein two of said cores having cellulose filter medium wrapped thereabout are inserted coaxially over said flow tube and secured by said continuous hot melt adhesive coating between contiguous surfaces.

12. A method of fabricating an axial flow depth filter assembly as described by claim 11 wherein said two cellulose medium wrapped cores are positioned axially along said flow tube with a small separation space between proximate ends.

13. A method of fabricating an axial flow depth filter assembly as described by claim 12 wherein apertures penetrate an annular wall of said flow tube adjacent said separation space.

14. A method of fabricating an axial flow depth filter assembly as described by claim 13 wherein an outer radial perimeter of said separation space is sealed by a bead of said hot melt adhesive.
